(19) United States
(12) Patent Application Publication
(10) Pub. No.: US 2012/0004936 A1
(43) Pub. Date: Jan. 5, 2012

(54) METHOD AND SYSTEM FOR FACILITATING ANCILLARY SERVICES

(75) Inventors: Jonathan Hamblett, Scottsdale, AZ (US); Michael Qualantone, Scottsdale, AZ (US); Jason Wynn, Fountain Hills, AZ (US)

(73) Assignee: American Express Travel Related Services Company, Inc., New York, NY (US)

(21) Appl. No.: 12/826,987

(22) Filed: Jun. 30, 2010

(51) Int. Cl. G06Q 50/00; G06Q 10/00

(52) U.S. Cl. 705/5

(57) ABSTRACT

Methods, systems and computer-readable mediums are provided for facilitating ordering ancillary services while implementing various policies and business rules and providing granular reconciliation of data. Travel information associated with a user is received from a computer reservation system. The method requests ancillary service content based upon the travel information. The ancillary service content is associated with the travel information. The system presents travel information and ancillary service content to the user and receives an ancillary service order from the user based upon the ancillary service content. The user receives confirmation of the service order and travel data is matched and associated enable detailed reconciliation and visibility into services ordered.

### FIELD OF THE INVENTION

The present invention generally relates to providing travel based services to users, and more particularly, to a computer-based system for facilitating ancillary services.

### BACKGROUND

In order to reduce costs and maximize revenue, many industries are unbundling services. For instance, many airline industry companies have recently unbundled various products and services (e.g., seat assignment, boarding preference, check-in baggage) that were previously free to travelers and have started charging the travelers separately for these services. The travelers include corporate travelers as well as leisure travelers. Further, the airlines are also offering various other services using ala carte pricing models, including a service class update, lounge access, food/beverages served on board, prioritized boarding and the like. In addition, the travelers are also availing additional services, such as, airport pick-up/drop, hotel reservation, car rental, entertainment, online access etc. that are relevant the travel.

Currently, many websites are available that present offers and/or content related to a specific type of ancillary service(s) from multiple service providers. A traveler can access such a website and select a desired service provider for one ancillary service. The traveler then often moves on to another website and books another ancillary service. According to another technique, the traveler may directly contact individual service providers separately for offers and/or content related to the ancillary services (e.g., ancillary service content) to book desired ancillary services.

However, current techniques suffer from many drawbacks. Current techniques are unable to provide total cost of the trip, since the ancillary services related to the travel are booked separately from different websites. Consequently, the traveler (and in particular, corporate travel departments) face difficulties in tracking and/or managing their expenses on corporate trips. Furthermore, transaction reports generated by currently available systems do not typically distinguish between transactions related to different ancillary services and may simply group such transactions under a common heading “miscellaneous”. Consequently, the corporations may not be able segregate reimbursable travel expenses from non-reimbursable expenses. Also, current systems do not typically take corporate policy, traveler preferences and service provider policy into account, during the ancillary service content purchase transaction. Given the foregoing, a long-felt need exists for facilitating the ancillary services to the travelers in an effective manner.

### SUMMARY OF THE INVENTION

The present invention meets the above-identified need by providing methods, systems and computer-readable mediums for facilitating ancillary services. According to one embodiment, a computer-based method for facilitating ancillary services includes receiving travel information associated with a user from a computer reservation system. The method requests ancillary service content based upon the travel information. The ancillary service content is associated with the travel information. The method presents at least a portion of the travel information and at least a portion of the ancillary service content to the user. An ancillary service order is received from the user based upon the ancillary service content and a confirmation of an ancillary service fulfillment is sent to the user.

According to one embodiment, there is disclosed a system for facilitating ancillary services. The system receives travel information associated with a user from a computer reservation system. The system further requests ancillary service content based upon the travel information received from the computer reservation system. The ancillary service content is associated with the travel information. The system presents at least a portion of the ancillary service content and at least a portion of the travel information to the user. The system receives an ancillary service order from the user based upon the ancillary service content. The system sends a confirmation of an ancillary service fulfillment to the user.

Further features and advantages of the present invention, as well as the structure and operation of various embodiments are described in detail below with reference to the accompanying drawings.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an overview of an exemplary system in which a merchandising system may be deployed, in accordance with various embodiments of the present invention;

FIG. 2 is a an exemplary block diagram of the merchandising system, in accordance with various embodiments of the present invention;

FIG. 3 is a diagram illustrating an exemplary user interface screen generated by the merchandising system, in accordance with various embodiments of the present invention;

FIG. 4 is a diagram illustrating an exemplary receipt generated by the merchandising system, in accordance with various embodiments of the present invention; and

FIG. 5 is a flowchart illustrating an exemplary computer-based method of implementing the merchandising system, in accordance with various embodiments of the present invention.

### DETAILED DESCRIPTION

The detailed description of exemplary embodiments of the invention herein makes reference to the accompanying drawings, which show exemplary embodiments by way of illustration and the best mode. While exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention is directed to systems, methods and computer programs for providing travel based ancillary services and/or products to users via a portal. The portal provides seamless (or close to seamless) integration of various ancillary services and/or products (herein collectively referred to as “ancillary services”) from a plurality of service providers. The user is presented with ancillary services related to travel information of the user. The user may select desired ancillary services. Upon fulfillment of the desired ancillary services, the user may be presented with a confirmation. Further, enhanced travel information is created by associating the selected ancillary service with the travel information. The user may be provided with a transaction report, based upon the enhanced travel information that distinguishes between the travel information and the ancillary services.

“Entity” may include any individual, consumer, group, business, organization, government entity, transaction account issuer or processor (e.g., credit, charge, etc), merchant, consortium of merchants, account holder, charitable organization, software, hardware, and/or any other entity.

A “user” is any entity that uses the services offered by the portal. For example, a user may be a corporate traveler, a leisure traveler and the like. In an embodiment, the users may also refer to travel counselors, utilizing the portal services. The user may utilize the portal with the help of the travel counselor.

A “service provider” is any entity providing services. In an embodiment, the services may be travel related services such as, for example, transportation ticket booking, hotel reservations and the like. In one embodiment, the service provider may also provide ancillary services such as, for example, seat assignment, seat upgrade, class of service upgrade, boarding preference, food, beverage, baggage fees, baggage handling preference, entertainment, online access, hotel reservations, travel insurance, car services, and the like. Examples of service providers include “American Airlines”, “Continental Airlines”, “Delta Airways”, “Travelocity,” “Avis,” “Cisco Telepresence,” “Intercontinental The Barclay”, “Carmellimo”, “Dial 7”, “Four Seasons Hotels” and the like.

The present invention is now described in terms of an exemplary system, hereinafter referred to as a “merchandising system,” in which an embodiment would be implemented. The merchandising system may be implemented by any entities such as, example, travel service companies, transaction account issuers, travel agencies, airlines, computer reservation systems, hotels and the like. The nomenclature used herein is for convenience only and is not intended to limit the application of the present invention. It will be apparent to one skilled in the relevant art(s) how to implement the present invention in alternative embodiments.

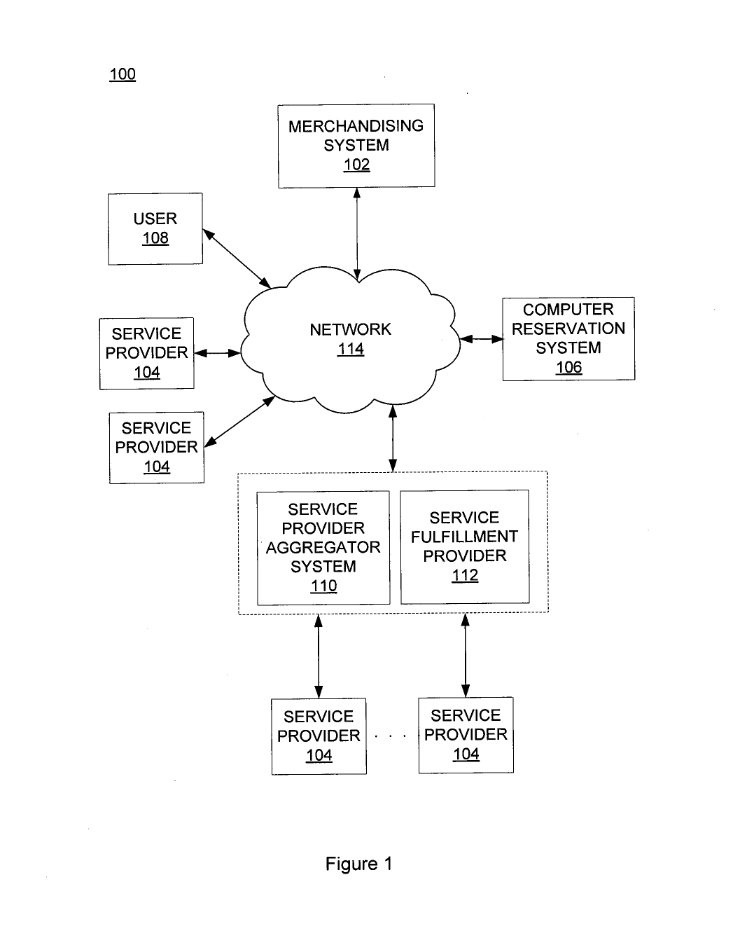

With reference to FIG. 1, in one embodiment, system 100 includes a merchandising system 102. System 100 may further include a plurality of service providers 104, computer reservation system 106, user 108, service provider aggregator system 110, service fulfillment provider 112 and a network 114.

In an embodiment, user 108 generates and sends a travel request to computer reservation system 106. The travel request may include information such as, for example, travel policy information, origin, destination, any intermediate destinations, travel dates, preferred airline(s), seat preferences, meal preferences and the like. Further, the travel request may be stored by computer reservation system 106. Further, computer reservation system 106 may generate travel information based on the received travel request.

User 108 may be, for example, a corporate traveler, a leisure traveler, a corporate client and the like. In an embodiment, user 108 may connect to merchandising system 102 using any client computing device known in the art. For example, a client comprises any hardware and/or software suitably configured to facilitate requesting, retrieving, updating, analyzing, entering and/or modifying data. Client includes any device (e.g., personal computer) which communicates (in any manner discussed herein) with any system described herein via any network discussed herein.

In an embodiment, computer reservation system 106 may include one or more of a global distribution system or an airline reservation system. In an embodiment, computer reservation system 106 may generate the travel information after identifying unique identity information associated with each user 108. Though a single computer reservation system 106 is depicted in FIG. 1, more than one computer reservation systems 106 may be communicatively coupled to the user 108 and the merchandising system 102.

In various embodiments, travel information may include at least one of a digital travel record and a passenger name record (PNR). The digital travel record may include details related to travel such as, for example, tour itinerary, details of transportation tickets, and the like.

In one embodiment, the computer reservation system 106 sends the travel information to the user in a message. The message may be, for example, a text message, an e-mail, and/or a message on the portal. According to one embodiment, the message includes a uniform resource locator (URL) by which user 108 may access various services provided by merchandising system 102. In various embodiments, computer reservation system 106 may send the message to user 108 directly. Alternatively, computer reservation system 106 may use a third-party service provider to deliver the message to user 108.

User 108 may access the merchandising system 102 by clicking on the URL or entering the URL in a web browser, thereby generating a second request for viewing the travel information. In an embodiment, user 108 may need to enter her credentials, for example, a username and a password to access merchandising system 102 via the URL. According to an embodiment, when user 108 uses a travel counselor, the travel counselor may enter user's 108 username and password, and then enter details of user 108. The merchandising system 102 receives the second request. In response to the second user request, the merchandising system 102 may request the travel information related to the user 108 from the computer reservation system 106. Merchandising system 102 then receives travel information from computer reservation system 106.

Further, merchandising system 102 may generate a request to one or more service providers 104 for ordering ancillary service content, based on the travel information received from the computer reservation system 106. For example, if user 108 has booked a ticket to London on an American Airlines flight, the merchandising system 102 may request ancillary service content from American Airlines and/or other service providers that contains ancillary services data (provider, availability, pricing and ordering information) associated with London. For example, a network operator in the United Kingdom (UK) offering a SIM card for the UK, or a hotel in London and the like. In one embodiment, ancillary service content includes one or more ancillary services along with the pricing related to each ancillary service.

In an embodiment, system 100 may also include a service provider aggregator system 110 communicatively coupled to service providers 104 and merchandising system 102. Service provider aggregator system 110 may receive ancillary service content from service providers 104 and aggregate the ancillary service content. In one embodiment, the merchandising system 102 may receive the ancillary service content directly from the service providers 104. In an alternate embodiment, the merchandising system 102 may receive the ancillary service content from the service provider aggregator system 110.

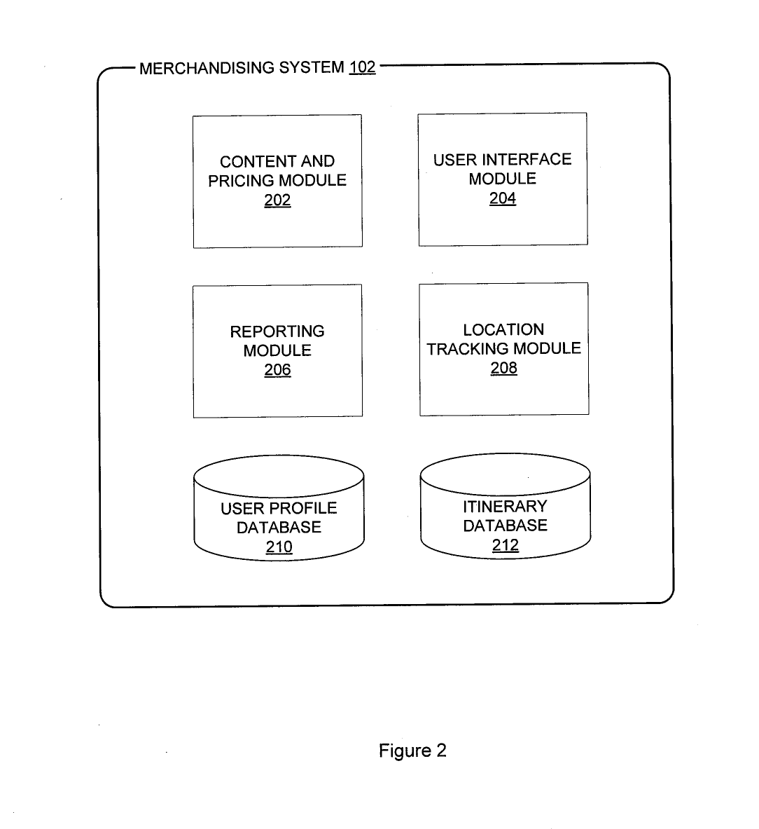

According to various embodiments, the merchandising system 102 may present at least a portion of the received ancillary service content and at least a portion of the travel information to user 108. In one embodiment, merchandising system 102 presents the travel information and the ancillary service content to user 108 using a web portal. The selection of respective portions of the ancillary service content and the travel information is further explained in conjunction with FIG. 2.

User 108 may then select one or more desired ancillary services from the presented ancillary service content. User 108 sends the selected ancillary services to merchandising system 102 in an ancillary service order. In an embodiment, merchandising system 102 forwards the ancillary service order to the service fulfillment provider 112 and service fulfillment provider 112 sends the ancillary service order to respective service providers 104.

In one embodiment, service fulfillment provider 112 may also be configured to receive payment details (for example, mode of payment, credit card information etc.) from user 108 and make payments to the respective service providers 104. In various embodiments, service fulfillment provider 112 provides a confirmation code to the merchandising system 102 (e.g., upon successful fulfillment of the ancillary service order). Merchandising system 102 receives the confirmation codes and sends a confirmation to user 108. In one embodiment, merchandising system 102 may send a confirmation to user 108 by, for example, displaying a confirmation message on the web portal, sending a text message, sending an e-mail etc. In an embodiment, the confirmation message includes the confirmation code. Service provider aggregator system 110 and service fulfillment provider 112 may be deployed by a third party. Service provider aggregator system 110 and/or service fulfillment provider 112 may also be integrated with merchandising system 102.

In an embodiment, merchandising system 102 associates the selected ancillary services with the travel information of the user 108 to create enhanced travel information. The enhanced travel information is used to generate consolidated reports corresponding to the user 108's travel information.

The different elements shown in system 100 may communicate with each other over network 114. “Network” includes any electronic communications means and incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards And Protocols (1998); Java 2 Complete, various authors, (Sybex 1999); Deborah Ray And Eric Ray, Mastering Html 4.0 (1997); and Loshin, TCP/IP Clearly Explained (1997) and David Gourley and Brian Totty, HTTP, The Definitive Guide (2002), the contents of which are hereby incorporated by reference.

Alternately, user 108 may communicate with the elements shown in system 100 over a web client (not shown). The web client comprises any hardware and/or software suitably configured to facilitate input, receipt and/or review of information discussed herein. The web client includes any device (e.g., personal computer), which communicates (in any manner discussed herein) with the merchandising system 102 via any network discussed herein. Such browser applications comprise Internet browsing software installed within a computing unit or system to conduct online transactions and communications. Practitioners will appreciate that web client may or may not be in direct contact with the systems (such as for example merchandising system 102). For example, web client may access the services of the various systems through another server, which may have a direct or indirect connection to network 114 or any of the systems described herein.

As those skilled in the art will appreciate, the web client includes an operating system (e.g., Windows NT, 95/98/2000, OS2, UNIX, Linux, Solaris, MacOS, etc.) as well as various conventional support software and drivers typically associated with computers. The web client may include any suitable personal computer, network computer, workstation, minicomputer, mainframe or the like. The web client can be in a home or business environment with access to a network. In an exemplary embodiment, access is through a network or the Internet through a commercially available web-browser software package. The web client may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. As used herein, “transmit” may include sending electronic data from one system component to another over a network connection. Additionally, as used herein, “data” may include encompassing information such as commands, queries, files, data for storage, and the like in digital or any other form.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., Alex Nghiem, IT Web Services: A Roadmap for the Enterprise (2003), hereby incorporated by reference.

With reference to FIG. 2, the merchandising system 102 includes content and pricing module 202, user interface module 204, reporting module 206 and location tracking module 208, according to an embodiment. The merchandising system 102 may further include user profile database 210 and itinerary database 212.

In an embodiment, the profile database 210 stores profiles of the users. A user profile includes information such as, without limitation, a username, a password, customer information, credit card details and the like. The customer information may include, for example, personal details of the customers such as name, date of birth, billing address, email address, social security number (SSN), and the like. Other examples of customer information include credit limit, annual income, profile information, demographic information, spending habits or trends, preferences, and the like. In an embodiment, the user's profile is linked to his profiles on the computer reservation system 106 and upon modifying any information on user profile database 210, merchandising system 102 may suitably modify the user's profile stored on computer reservation systems 106.

Itinerary database 212 may store information related to users' itinerary, such as for example, originating point, destination point, intermediate destinations, number of days at each destination, travel dates, modes of travel, travel history, travel preferences, and/or the like. Itinerary database 212 may also store information relating to the ancillary services provided earlier to the user.

In an embodiment, content and pricing module 202 filters ancillary service content received from service providers 104 either directly or via the service provider aggregator system 110. For example, the ancillary service content may be filtered based on one or more of traveler preference, corporate policy, agency policy and service provider policy. In an embodiment, content and pricing module 202 obtains policy information such as, for example, traveler preference, corporate policy, agency policy and the service provider policy. Content and pricing module 202 analyzes the policy information and creates business rules based upon the analysis. Content and pricing module 202 filters the ancillary service content based upon the business rules. In an embodiment, content and pricing module 202 uses business rules to determine whether the ancillary service order is valid, feasible, authorized and/or recommended.

Traveler preference may include, for example, airline preferences, food preferences, communication related preferences, hotel preferences, and the like. Airline preference may include information such as, for example, seating preference, boarding preference, baggage handling preference, lounge room preference and the like. Communication related preferences may be, for example, internet access requirements, whether the user typically uses country/location specific subscriber identity module (SIM) cards and the like. The hotel preferences may further include information such as, for example, room preference, grade of the hotel, location of the hotel and the like. Examples of food preferences include whether user 108 prefers vegetarian/non-vegetarian food, preferred cuisine, special food requirements etc.

Corporate policy includes one or more policies defined by a corporate client. For example, corporate policy may include hierarchy based policy, airline preferences, preferred service providers and the like. In an embodiment, hierarchy based policy includes rules for ordering and reimbursement of ancillary services depending upon employee's designation, for example, a Vice President may be authorized to upgrade seating class in an airplane, but a Manager is not eligible to upgrade seating class.

Service provider policy may include one or more rules defined by individual service providers. One example of a service provider policy may be that if the traveler has upgraded his seat to business class, he may access to the lounge room for free.

In various embodiments, agency policy may be policies implemented by the agency deploying merchandising system 102. For example, the agency may give a corporate traveler an option of receiving a certain internet plan for free, while a leisure traveler may have to pay for the same service. In another example, the agency may allow only premium users to pay for the ancillary services using membership reward points awarded by the agency.

Content and pricing module 202 may also provide user 108 with an opt-in/opt-out capability. The user 108 may opt out of specific type(s) of ancillary services, for example, the user 108 may not want to receive any content related to lounge-room facilities. Similarly, the user 108 may opt out from the ancillary service content from specific service provider(s) 104, for example, the user 108 may not want to receive any content from XYZ Hotel. This may provide the user 108 with a concise list of service providers 104 which may be relevant and useful to the user 108.

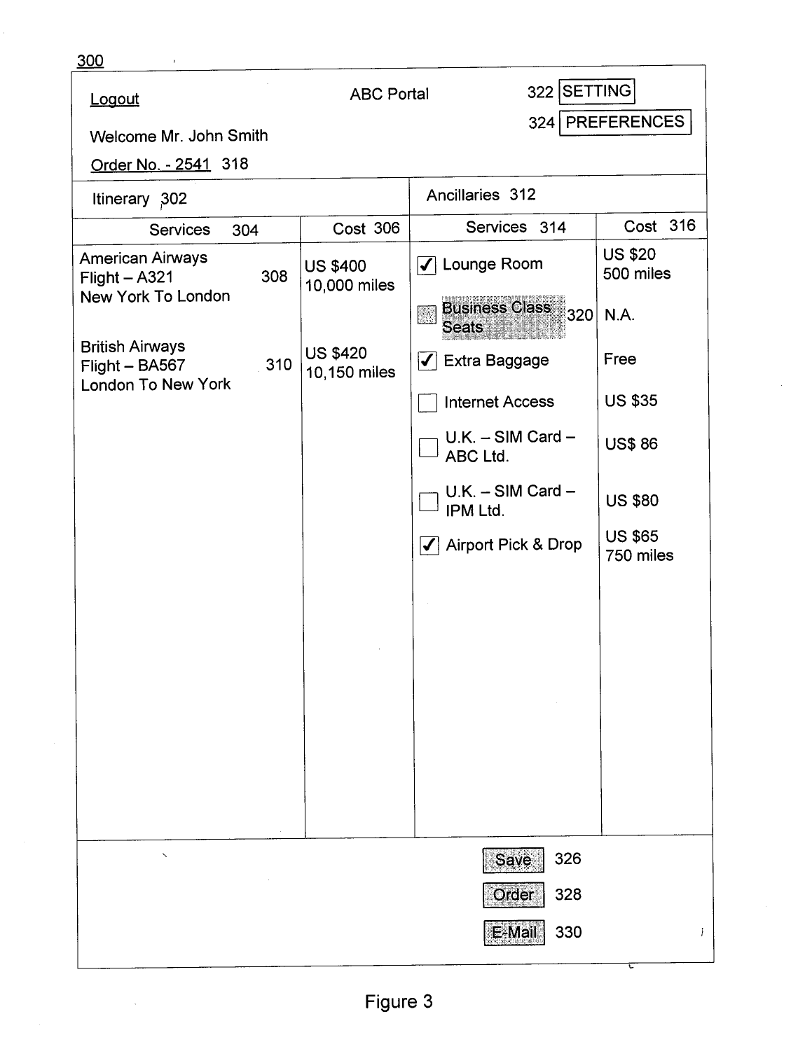

User interface module 204 may be responsible for organizing, preparing and presenting the user interface to user 108. The user interface module 204 may present the data using a web portal. The user interface may be provided on communication devices such as, for example, a computer, a mobile phone, PDA, laptop, and the like. An example user interface will be explained in conjunction with FIG. 3.

The user interface module 204 may be responsible for providing a login authentication capability. The user interface module 204 may implement single sign-on (SSO) capability. This may facilitate user 108 to login to the merchandising system 102 and the computer reservation system 106 by only logging in from the merchandising system 102. This SSO capability may be useful for simultaneously updating the user profile database 210 in merchandising system 102 and computer reservation system 106 (e.g., as explained above).

User interface module 204 may allow user 108 to enter one or more modes of payment for the selected ancillary services. User 108 may make payment using a financial transaction account, for example, a smart card, a fob, an RFID enabled device, a corporate card, a personal credit card, a debit card, a pre-paid card and the like. Further, user interface module 204 may also support payment with different currencies. Other forms of payment may include, but are not limited to, membership reward points, foreign currency, airline frequent flier miles, central billing account, and the like.

Further, user interface module 204 may generate the user interface in various languages. User interface module 204 may also display advertisements on the user interface. User 108 may have an option to opt-in/opt-out of being presented the advertisements.

In an embodiment, reporting module 206 may receive the confirmation code from service fulfillment provider 112. Reporting module 206 may also be configured to associate the travel information with the ancillary services to create enhanced travel information and generate a report based on the enhanced travel information. The report may further include the cost of all the services received from content and pricing module 202.

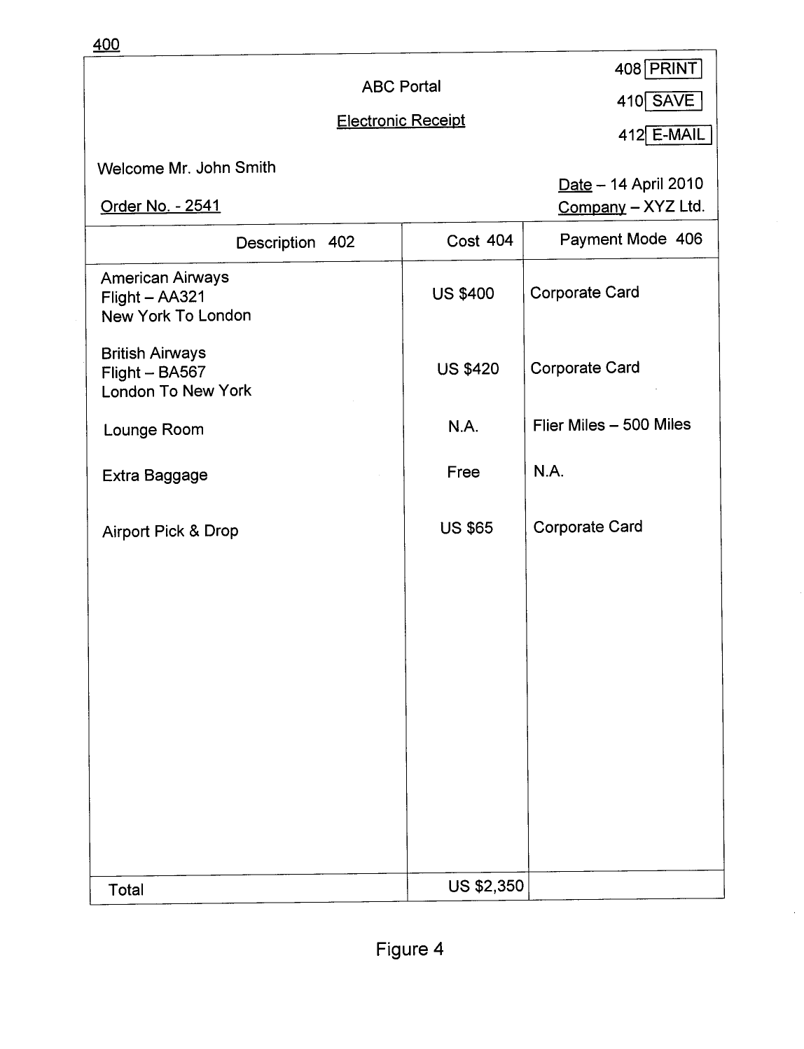

The report may be an employee travel and expense report. In a further embodiment, the report differentiates between the travel information and the ancillary service content. The report may also provide details about the modes of payment used to pay for each of the selected ancillary services. One example report is described in conjunction with FIG. 4. In a further embodiment, on confirmation of successful transactions, the reporting module 206 may also generate a receipt. The receipt may include details such as, for example, ancillary service description, service provider, the amount incurred, mode of payment and the like.

User interface module 204 may further display the report to user 108 on a web portal. Merchandising system 102 may also e-mail the report to the respective user 108. Further, the report may be generated in a plurality of languages selectable by user 108. The user interface module 204 may also retrieve and display the reports of the past, present and future itineraries related to each user 108. In an embodiment, user 108 is able to print any of the reports multiple times. In various embodiments, the report is stored by user interface module 204 in itinerary database 212, or user profile database 210 or both.

The merchandising system 102 enables the user 108 to order the travel related services and/or ancillary services during the travel. In one such example, while preparing the itinerary, user 108, may not have purchased a pick and drop service, but upon reaching the destination, he may opt to book it. In another example, user 108 misses a flight wants to book a hotel room. User 108 accesses merchandising system 102 via the URL and sends a new ancillary service order. Reporting module 206 reconciles such transactions using, for example, the digital travel record and/or the PNR. In a further embodiment, reporting module 206 may store the details of such transactions in itinerary database 212. In an embodiment, such transactions may be stored on a separate database.

Merchandising system 102 may allow user 108 to perform a transaction directly with service provider 104. In this case, service provider 104 sends details of the transaction to reporting module 206, and the reporting module 206 uses these details to reconcile with other transactions associated with the user 108. The reconciliation may be done using the PNR, the digital travel record, an order number, an itinerary number and the like.

In various embodiments, merchandising system 102 provides location based services. For example, location tracking module 208 tracks the location of user 108 and provides the user 108 with various offers and/or services. The tracking of location may be done using various techniques known in the art, such as, for example, global positioning system (GPS), GSM tracking, Wi-Fi based tracking and the like. For example, if the location tracking module 208 detects that the user 108 is near Niagara Falls, merchandising system 102 may send food coupons of different restaurants, discounts for shops located near Niagara Falls. The coupons may be sent to the user 108's device, for example, a mobile phone, a PDA, a laptop and the like.

According to another example, if the user 108 is at an airport and misses a connecting flight, the airline (i.e. a service provider) may notify merchandising system 102. Merchandising system 102 contacts relevant service providers 104 to obtain ancillary service content, for example, lounge room facilities and/or hotels near the airport and present the ancillary service content to user 108. User 108 may select one or more of the presented ancillary services. As described earlier, reporting module 206 may reconcile such transactions with the user 108's enhanced travel information.

System 100 and/or merchandising system 102 (or any of the components described herein) may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: user database 210, itinerary database 208, and/or like databases useful in the operation of system 100 and/or merchandising system 102. As will be appreciated by one of ordinary skill in the art, one or more of the components of system 100 and/or merchandising system 102 may be embodied as a customization of an existing system, an add-on product, upgraded software, a stand alone system (e.g., kiosk), a distributed system, a method, a data processing system, a device for data processing, and/or a computer program product. Accordingly, individual system 100 and/or merchandising system 102 components may take the form of an entirely software embodiment, an entirely hardware embodiment, or an embodiment combining aspects of both software and hardware. Furthermore, individual system 100 and/or merchandising system 102 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

User profile database 210 and/or itinerary database 212 may include any hardware and/or software suitably configured to facilitate storing information as described herein. One skilled in the art will appreciate that merchandising system 102 may employ any number of databases in any number of configurations. Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/DEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 100, a portion or all of the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken.

One skilled in the art will also appreciate that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like.

With reference to FIG. 3, a user interface 300 is generated by merchandising system 102 for presenting the travel information and the ancillary services to the user 108. Column 302 shows an exemplary view of user 108's itinerary. In an embodiment, column 304 is used for displaying travel information and column 306 displays corresponding cost. As shown, fields 308 and 310 display two segments of the user's itinerary. The column 312 represents the ancillary service content related to the user's itinerary. The data and layout displayed in FIG. 3 is exemplary to one embodiment and may vary to accommodate space and usability considerations, e.g., user interface 300 is presented, in an embodiment on a mobile device such as a phone, PDA, news reader, tablet, netbook, etc.

Column 314 displays description of the ancillary services and column 316 displays corresponding pricing. User 108 selects desired ancillary services, for example, by clicking on an appropriate check box as shown in FIG. 3. In the illustrated example, the user 108 has selected the Lounge room access, extra baggage and the airport pick & drop services.

Field 318 denotes an order number of the current itinerary. In one embodiment the order number may be used for tracking purposes, for example, reconciling the transactions. In additional embodiments, field 318 may display the PNR associated with the itinerary.

In one embodiment, user interface module 204 may disable (or “gray out”) fields. For example, user interface module 204 may disable fields if user 108 is restricted based upon the business rules, from selection a particular option or a particular combination of options. For example, assuming that user 108, here, Mr. John Smith, is a manager at a company XYZ Ltd. and he may not qualify for the option of upgrading his seating class according to the policies of XYZ Ltd.; hence field 320 with an option of upgrading his sitting class has been disabled (as indicated by the gray color of field 320).

In an embodiment, user interface 300 includes buttons such as, SETTING 322 and PREFERENCES 324 for allowing user 108 to modify the settings and preferences, respectively. In an embodiment, user 108 clicks on the SETTING 322 button and a separate interface is provided to user 108 to enable modification of user settings. The separate interface may be provided in the same web page or a new web page may be opened. In various embodiments, the settings include options for changing user details such as, password, credit card details, mailing address and the like. Similarly, the user 108 may clicks on the button PREFERENCES 324 to modify the preferences. In a further embodiment the PREFERENCES 324 button includes options for changing details such as, choice of food, seating preference, airline preference and the like.

In an embodiment, user interface 300 may further include buttons SAVE 326, ORDER 328 and E-MAIL 330. The SAVE 326 button enables the user 108 to save the selection of the ancillary services for a possible modification at a later point in time. User 108 clicks ORDER 328 button and is directed to another page which enables user 108 to choose and confirm the payment mode for ancillary services. Further, a confirmation receipt may be generated on successful completion of the transactions. An exemplary receipt is illustrated in FIG. 4. Further, user 108 may e-mail the itinerary details along with the selected ancillary services to any e-mail account for record and data logging purposes by clicking on the E-MAIL button 330.

With reference to FIG. 4, a receipt is generated by merchandising system 102 for confirming an order placed by the user. A person of ordinary skill in the art will appreciate that the given receipt is merely an example illustration depicting a sample receipt generated by the user interface module 204 by which it may report the details of the transaction to the user 108. The numbers and data shown in the figure are merely on an illustrative basis and do not limit the scope of the invention. In an embodiment, Description field 402 may be used to display the description of the travel information, and the selected ancillary services. A cost 404 displays the respective costs. Field 406 is used for displaying the payment mode selected by the user 108 on the user interface 300. The user 108 prints the receipt by clicking on the PRINT 408 button shown in FIG. 4. The user 108 saves the receipt by clicking on the SAVE 410 button and print the receipt later. The receipt may also be e-mailed to any account for record and logging by clicking on the E-MAIL 412 button.

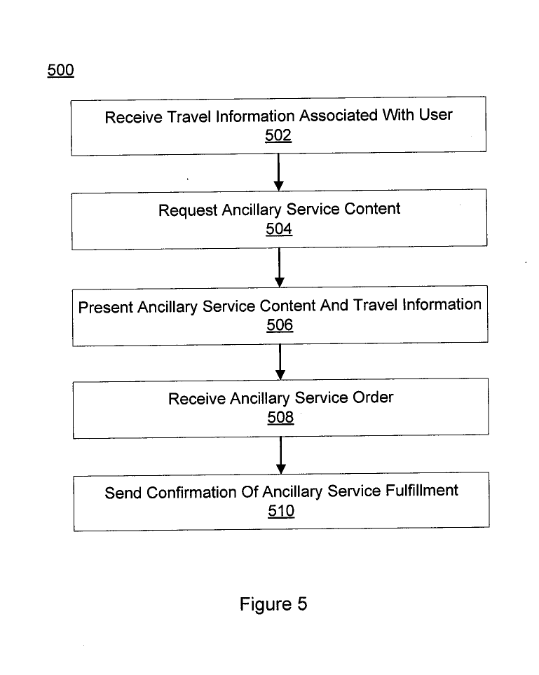

With reference to FIG. 5, user 108 may generate a travel request to computer reservation system 106. Computer reservation system 106 may send a message to user 108 upon successful completion of the travel request. In one embodiment, the message includes a URL for accessing merchandising system 102. In an embodiment, the URL may enable User 108 to send a second request to merchandising system 102. In one embodiment, the URL is the address of a web site or web portal where user 102 may shop for and select ancillary services. Upon receiving the second request, merchandising system 102 requests travel information associated with user 108 from computer reservation system 106. In an embodiment, computer reservation system 106 automatically sends travel information to merchandising system 102. Merchandising system 102 receives the travel information related to the user 108 from the computer reservation system 106 (step 502). Computer reservation system 106 may include, for example, one or more of a global distribution system, an airline reservation system and the like. In an embodiment, the travel information may be based upon the travel request generated by user 108. In an embodiment, the travel information may be at least one of a digital travel record and a passenger name record.

The merchandising system 102 requests ancillary service content based on the travel information (step 504). In an embodiment, the merchandising system 102 may request the ancillary service content from the plurality of service providers 104 and may receive respective ancillary service content directly from the plurality of service providers 104. In another embodiment, the merchandising system 102 sends a request for the ancillary service content to the service provider aggregator system 110, which forwards the request to the plurality of service providers 104. In an embodiment, the service provider aggregator system 110 merges the ancillary service content received from the plurality of service providers 104 and forwards the merged ancillary service content to merchandising system 102.

In one embodiment, merchandising system 102 sends a real time, or near real-time, request for content to a service provider. The service provider may send a response that is customized based upon, for example, user 108 (e.g. customer) profile, travel history, previously received feedback, etc. In an embodiment, a service provider may send bundled ancillary services; i.e. one or more ancillary service grouped together for sale. For example, an airline may bundle an first-class upgrade and a lounge access for a single price. Bundling allows service providers to drive additional demand and revenue. In an embodiment, a business rules engine associated with merchandising system 102 executes business rules to bundle goods and/or services of one or more service provider.

Merchandising system 102 presents at least a portion of the ancillary service content and at least a portion of the travel information to user 108 (step 506). In an embodiment, merchandising system 102 filters the ancillary service content received from the plurality of service providers 104 based upon a business rule to identify the portion of ancillary service content. In various embodiments, the business rules may be generated based on at least one of traveler's preferences, corporate policy, agency policy and service provider policy. In an embodiment, merchandising system 102 includes a business rules engine that enables input, configuration, organization, management, validation and execution of business rules. For example, the business rules engine enables a user (e.g., a business manager) to configure business rules (e.g. for determining whether expenses are reimbursable).

In an embodiment, the merchandising system 102 may provide ancillary service content and travel information on a web portal. User 108 selects one or more of the plurality of ancillary services and merchandising system 102 generates an ancillary service order for the selected ancillary services.

Merchandising system 102 receives the ancillary service order from user 108 (step 508). In an embodiment, the merchandising system 102 forwards the ancillary service order to service fulfillment provider 112. Service fulfillment provider 112 may further send the ancillary service order to respective service provider(s) 104. In an embodiment, the service fulfillment provider 112 may provide confirmation, for example, in terms of a confirmation code, to the merchandising system 102 on fulfillment of the ancillary service order. In one embodiment, the merchandising system 102 may directly send the selected services to the respective service providers 104. The merchandising system 102 provides the confirmation to the user 108 on fulfillment of the request for ancillary service contents (step 510).

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C or ‘at least one of A, B, or C is used in the claims or the specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

We claim:

1. A method comprising:
receiving, by a computer for facilitating ancillary services and from a computer reservation system, travel information associated with a user;
requesting, by the computer and based upon the travel information, ancillary service content associated with the travel information;
presenting, by the computer, at least a portion of the ancillary service content and at least a portion of the travel information to the user;
receiving, by the computer and from the user, an ancillary service order based upon the ancillary service content; and
sending, by the computer and to the user, a confirmation of an ancillary service fulfillment based upon the ancillary service request.

2. The method of claim 1, further comprising receiving, by the computer and from a user via a uniform resource locator (URL), a second user request to view the travel information.

3. The method of claim 2, wherein the URL is sent to the user in a message in response to a travel request being received by the computer reservation system, wherein the travel information is created based upon the travel request.

4. The method of claim 3, wherein the message comprises at least one of an email message, a text message and a message on a travel portal.

5. The method of claim 1, wherein ancillary service content comprises a plurality of ancillary services with respective pricing for each service.

6. The method of claim 1, wherein the travel information comprises at least one of a digital travel record and a Passenger Name Record (PNR).

7. The method of claim 1, wherein the travel information is received from at least one of a global distribution system or an airline reservation system.

8. The method of claim 1, wherein the presenting comprises presenting in at least one of a web interface and a web portal.

9. The method of claim 1, further comprising receiving ancillary service content from a plurality of service providers.

10. The method of claim 1, wherein the ancillary service content comprises at least one of seat assignment, seat upgrade, class of service upgrade, boarding preference, food, beverage, baggage fees, baggage handling preference, entertainment and online access.

11. The method of claim 1, further comprising associating the travel information with the ancillary service in order to create enhanced travel information.

12. The method of claim 1, further comprising generating a report based upon the enhanced travel information.

13. The method of claim 12, wherein the report comprises an employee travel and expense report that provides detail separating the travel information from the ancillary service order.

14. The method of claim 1, further comprising sending the ancillary service order to a service fulfillment provider, wherein the service fulfillment provider places the ancillary service order and provides a confirmation code.

15. The method of claim 1, further comprising receiving ancillary service content from a service provider aggregator system that aggregates content from a plurality of service providers.

16. The method of claim 1, further comprising filtering the ancillary service content based upon at least one of traveler preference, a corporate policy, an agency policy and a service provider policy.

17. The method of claim 1, further comprising:
obtaining policy information by obtaining at least one of a traveler preference, a corporate policy, an agency policy and a service provider policy;
analyzing the policy information; and creating business rules based upon the analyzing.

18. The method of claim 17, further comprising at least one of: filtering the ancillary service content based upon the business rules, and determining whether the ancillary service order is valid based upon the business rules.

19. A system comprising:
a network interface communicating with a memory;
the memory communicating with a processor; and
the processor, when executing a computer program, is configured to:
receive, from a computer reservation system, travel information associated with a user;
request, based upon the travel information, ancillary service content associated with the travel information;
present at least a portion of the ancillary service content and at least a portion of the travel information to the user;
receive from the user, an ancillary service order based upon the ancillary service content; and
send to the user, a confirmation of an ancillary service fulfillment based upon the ancillary service request.

20. A tangible, non-transitory computer-readable medium having computer-executable instructions stored thereon that, if executed by a computer for facilitating ancillary services, cause the computer to perform operations comprising:
receiving, by the computer and from a computer reservation system, travel information associated with a user;
requesting, by the computer and based upon the travel information, ancillary service content associated with the travel information;
presenting, by the computer, at least a portion of the ancillary service content and at least a portion of the travel information to the user;
receiving, by the computer and from the user, an ancillary service order based upon the ancillary service content; and
sending, by the computer and to the user, a confirmation of an ancillary service fulfillment based upon the ancillary service request.
